(19) United States
(12) Patent Application Publication
(10) Pub. No.: US 2007/0244675 A1
(43) Pub. Date: Oct. 18, 2007

(54) Method and Apparatus for Optimizing Multidimensional Systems

(75) Inventors: Offer Shai, Yavne (IL); Daniel Rubin, Tel Aviv (IL)

Correspondence Address: Martin D. Moynihan;PRTSI, P.O.Box 16446, Arlington, VA, 22215, US

(73) Assignee: RAMOT AT TEL AVIV UNIVERSITY LTD., TEL-AVIV (IL)

(21) Appl. No.: 11/578,960

(22) PCT Filed: Apr. 21, 2005
(86) PCT No.: PCT/IL05/00435

§ 371 Date: Oct. 19, 2006

Related U.S. Application Data
(60) Provisional application No. 60/564,204, filed on Apr. 22, 2004.

(51) Int. Cl. G06F 17/10

(52) U.S. Cl. 703/2

(57) ABSTRACT

Method for optimizing a flow network is disclosed. The method comprises: constructing a multidimensional graph representation which is characterized by a plurality of vertices and a plurality of edges, whereby at least one edge of the plurality of edges is associated with a vector quantity over the flow network. The method further comprises formulating a linear programming model over the multidimensional graph representation, and using a linear programming algorithm for obtaining a substantially optimal solution to the linear program model.

### FIELD AND BACKGROUND OF THE INVENTION

The present invention relates to optimization and, more particularly, to a method and apparatus for optimizing multidimensional systems, such as, but not limited to, flow networks and plastic systems.

A well known mathematical tool for representing many engineering systems is graph theory. Graph theory is the mathematical study of properties of formal mathematical structures called graphs. A graph is a finite set of points, termed vertices or nodes, connected by links termed edges or arcs. A graph thus generally defines a set of vertices and set of pairs of vertices, which are the edges of the graph. There are several types of graphs in graph theory. The type of a particular graph largely depends upon the features of its components, namely the attributes of its vertices and edges. For example, when the set of pairs includes only distinct elements, the graph is called a simple graph; when one or more pairs are connected by multiple edges the graph is called a multigraph; when one or more vertices are connected to themselves the graph is called a pseudograph; when the edges are assigned with directions the graph is called a directed graph or a digraph; and when the pairs of vertices are unordered the graph is called undirected.

Graph theory is widely used in the field of engineering (see, e.g., Seshu S. and Reed M. B., 1961, “Linear Graphs and Electrical Networks”, Addison-Wesley; McPhee J. J., 1996, “On the Use of Linear Graph Theory in Multibody System Dynamics”, Nonlinear Dynamics, 9:73-90). Analogy on the basis of graph theory between different one dimensional systems such as dynamics, electricity and heat transfer is well known in the literature (see, for example, Cha et al., 2000, “Fundamentals of Modeling and Analyzing Engineering Systems”, Cambridge University Press, Cambridge).

Methods aimed at unified analysis of systems composed of elements from different engineering disciplines are mainly based the transformation all the elements to equivalent elements from only one discipline. One of the earlier techniques involved the transformation of all the engineering systems to equivalent electrical circuits [Kron, G., 1963 “Diakoptics—the piecewise solution of large-scale systems”, Macdonald, London]. More recently, it was suggested to transform elements in macromodels of Microelectromechanical systems (MEMS) to equivalent electrical elements upon which both analysis and design are then performed (Senturia 2001).

The mathematical properties of the graph representations map the physical laws underlying the behavior of the engineering system of interest. The correspondence between engineering systems and graph representations makes it possible to transfer engineering knowledge to graph representations, and the mathematical knowledge of graph representations to the engineering systems. In particular, graph representation can be used for solving engineering problems by transforming engineering knowledge between systems via graph variables (Shai O., 2001, “The Multidisciplinary Combinatorial Approach and its Applications in Engineering”, AIEDAM—AI for Engineering Design, Analysis and Manufacturing, 15(2):109-144).

To date, graph representations have been used in many engineering applications, including, the analysis of integrated engineering systems [Shai O. and Rubin D., 2003, “Representing and Analyzing Integrated Engineering Systems through Combinatorial Representations”, Engineering with Computers, 19(4):221-232, 2003], the systematic design of engineering systems [Shai O., 2003, “Design through Common Graph Representations”, ASME Design Engineering Technical Conferences, Chicago, 2003], the relations between different engineering fields [Shai O., 2001, “The Duality Relation between Mechanisms and Trusses”, Mechanism and Machine Theory, 36(3):343-369; Shai O., 2002, “Utilization of the Dualism between Determinate Trusses and Mechanisms”, Mechanism and Machine Theory, 37(11): 1307-1323]; the relations between different known methods in engineering [Shai O., 2001, “Deriving Structural Theorems and Methods Using Tellegen's Theorem and Combinatorial Representations”, International Journal of Solids and Structures, 38:8037-8052]; and the validation of engineering systems [Shai O. and Preiss K., 1999, “Isomorphic Representations and Well-Formedness of Engineering Systems”, Engineering with Computers 15:303-314].

Graph representation can be applied to analysis as well as design problems. The former deals with predicting the behavior of an engineering system, and the latter deals with synthesis of new engineering systems to produce some required behavior. Representative examples of analysis and design problems solvable by graph representation include mechanical linkages, trusses, skeletal structures, dynamical systems, gear trains, electronic circuits and hydraulic systems.

Of particular interest to the present invention is the relation between plastic systems and flow network systems. Plastic analysis involves the determination of the stress and strain in a mechanical component when certain portions of the component are above the yield stress. Traditionally, plastic analysis is performed numerically by various approximation methods, such as finite element methods.

Various attempts have been made in the past to optimize plastic systems via linear programming [Charnes A. and Greenberg, H. J., 1951, “Plastic Collapse and Linear Programming”, American Mathematical Society, 506; Prager, W., 1965, “Mathematical Programming and Theory of Structures”, J. of the Society for Industrial and Applied Mathematics, 13(l):312-332; Maier, G., 1970, “A Matrix Structural Theory of Piecewise Linear Plasticity with Interacting Yield Planes”, Meccanica 5:54-66].

Linear programming (LP) is an application of linear algebra that has been developed within the past half a century as a technique for determining optimal allocation of scarce resources. LP is a procedure that has found practical application in many areas, including, manpower management, agriculture, economics, transportation, advertising, engineering and others. The field of LP was essentially created in 1946, when George B. Dantzig defined its scope and proposed the first method for the practical solution of LP problems, called the simplex method. A typical LP problem is formulated in terms of a linear objective function to be optimized subject to a set of linear constraints describing relations among variables which represent resources.

Every LP problem, for which a particular objective function is to be optimized while satisfying a particular set of constraints, can be rewritten to require the optimization of a different, but related, objective function under a different, but related, set of constraints (to this end see, e.g., Papadimitriou C. H. and Steiglitz, K., 1982, “Combinatorial Optimization-Algorithms and Complexity”, Prentice-Hall, New Jersey). The original and rewritten problems are known in the literature as the primal and the dual problems, where, typically, the original problem is called the primal problem while the rewritten problem is called the dual problem. The primal and dual problems are, however, equivalent in a sense that every primal problem is dual to its dual problem and vice versa. The primal and dual problems approach a common solution from opposite directions. The solution to the dual problem is known to be useful, for example, in sensitivity analysis, where it is desired to determine the effect of parameter variations on the optimum solution. Additionally, the dual problem can be used to define criteria for terminating calculations when the primal and the dual allocation values are within some arbitrarily small value of each other.

Flow network analysis involves the determination of flow characteristics in directed networks. For example, in a problem, known as one-dimensional max-flow problem, one finds the maximal flow in a particular network line such that the flows in other network lines do not exceed the allowed capacities of these lines.

A one-dimensional truss maximal loading problem is equivalent to the max-flow problem in a network, whereby the equivalence is between the network lines (edges on the theory representation of the network) and the rods of the truss [see, e.g., Prager, W., 1965, “Mathematical Programming and Theory of Structures”, J. of the Society for Industrial and Applied Mathematics, V 13:1,312-332; Ford, L. R. and Fulkerson D. R., 1962, “Flows in Networks”, Princeton University Press, NJ]. This equivalence is typically realized by identifying flows through the network edges as forces acting in the corresponding truss rods. Accordingly, the capacities of the edges are set equal to the yield limits of the rods.

Prior art attempts to optimize flow networks were limited to rather simple, one dimensional problems. It is recognized, however, that one dimensional flow network is insufficient for many engineering applications, in particular engineering applications, such as plane and spatial trusses, in which the variables posses vector characteristics.

There is thus a widely recognized need for, and it would be highly advantageous to have a method and apparatus for the analysis of multidimensional flow, devoid of the above limitations.

### SUMMARY OF THE INVENTION

According to one aspect of the present invention there is provided a method of optimizing a flow network. The method comprises: constructing a multidimensional graph representation, which is characterized by a plurality of vertices and a plurality of edges, whereby at least one edge of the plurality of edges is associated with a vector quantity over the flow network. The method further comprises formulating a linear programming model over the multidimensional graph representation, and using a linear programming algorithm for obtaining a substantially optimal solution to the linear program model.

According to further features in preferred embodiments of the invention described below, the method further comprises using the substantially optimal solution for determining a maximal load of a multidimensional static system corresponding to the multidimensional graph representation.

According to another aspect of the present invention there is provided a method of determining a maximal load of a multidimensional static system. The method comprises: constructing a multidimensional graph representation, which is characterized by a plurality of vertices and a plurality of edges, whereby at least one edge of the plurality of edges is associated with a vector quantity over the multidimensional static system. The method further comprises formulating a linear programming model over the multidimensional graph representation, and using a linear programming algorithm for a obtaining a substantially optimal solution to the linear program model.

According to further features in preferred embodiments of the invention described below, the method further comprises formulating a transformed linear programming model over the multidimensional graph representation.

According to still further features in the described preferred embodiments the method further comprises formulating a first dual linear programming model over the multidimensional graph representation, the first dual linear programming model being complementary to the linear programming model.

According to still further features in the described preferred embodiments the linear programming algorithm is configured to halt execution when the first dual linear programming model satisfies a predetermined halting condition.

According to still further features in the described preferred embodiments the method further comprises formulating a second dual linear programming model over the multidimensional graph representation, the second dual linear programming model being complementary to the transformed linear programming model.

According to still further features in the described preferred embodiments the linear programming algorithm is configured to halt execution when the second dual linear programming model satisfies a predetermined halting condition.

According to still further features in the described preferred embodiments the transformed linear programming model is defined by inverting a respective vector quantity of at least one edge of the plurality of edges.

According to still further features in the described preferred embodiments the first and/or second dual linear programming model comprises potential variables being associated with vertices of the multidimensional graph representation, and potential-difference variables being associated with edges of the multidimensional graph representation.

According to still further features in the described preferred embodiments the potential variables correspond to displacements of joints of the multidimensional static system.

According to still further features in the described preferred embodiments the potential-difference variables correspond to length variations of rods of the multidimensional static system.

According to yet another aspect of the present invention there is provided an apparatus for determining maximal load of a multidimensional static system. The apparatus comprises: a graph constructor, for constructing a multidimensional graph representation of the multidimensional static system, as described above; and a linear programming unit for formulating a linear programming model over the multidimensional graph representation. According to further features in preferred embodiments of the invention described below, the linear programming unit is configured to apply a linear programming algorithm so as to obtain a substantially optimal solution to the linear program model, thereby to determine the maximal load of the multidimensional static system.

According to still further features in the described preferred embodiments the linear programming algorithm comprises a primal-transformed algorithm. According to still further features in the described preferred embodiments the primal-transformed algorithm is configured to iteratively update the substantially optimal solution using at least one augmentation coefficient.

According to still further features in the described preferred embodiments the vector quantity is a two-dimensional vector quantity.

The present invention successfully addresses the shortcomings of the presently known configurations by providing a method and apparatus for analyzing multidimensional flow.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a flowchart diagram of a method suitable for of optimizing a flow network or determining a maximal load of a plastic system, according to various exemplary embodiments of the invention;

FIGS. 2a-b are schematic illustrations of a one-dimensional flow network (FIG. 2a) and a one dimensional truss (FIG. 2b), according to the prior art;

FIGS. 3a-b are schematic illustrations of a two-dimensional flow network (FIG. 3a) and its corresponding two-dimensional plastic system (FIG. 3b), according to various exemplary embodiments of the invention;

FIG. 4 is a schematic illustration of one rod of a two-dimensional plastic system before and after deformation, according to various exemplary embodiments of the invention;

FIG. 5 is a schematic illustration of an apparatus for of optimizing a flow network or determining a maximal load of a plastic system, according to various exemplary embodiments of the invention;

FIG. 6 is a flowchart diagram of an iterative procedure linear programming algorithm, which can be used in various exemplary embodiments of the invention;

FIG. 7 is a schematic illustration of a truss for which a maximal load was determined, according to a preferred embodiment of the present invention;

FIGS. 8a-c are schematic illustrations of a first (FIG. 8a), second (FIG. 8b) and third (FIG. 8c) iterations to determine the maximal load of the truss of FIG. 7, according to a preferred embodiment of the present invention;

FIG. 8d is a schematic illustration the truss of FIG. 7, once a solution was obtained according to a preferred embodiment of the present invention; and

FIGS. 9a-f are a schematic illustrations of a ten-rod truss for which a maximal load was determined by an iterative procedure, according to a preferred embodiment of the present invention, where FIGS. 9a, 9c and 9e illustrate the truss at the beginning of the first (FIG. 9a), second (FIG. 9c) and third (FIG. 9e) iteration, FIGS. 9b and 9d illustrate the truss at the end of the first (FIG. 9b) and second (FIG. 9d) iteration, and FIG. 9f illustrates the truss when a halting condition is achieved.

### DESCRIPTION OF THE PREFERRED EMBODIMENTS

The present invention is of methods and apparatus which can be used for optimizing flow networks and plastic systems. Specifically, the present invention can be used to solve multidimensional max flow problems and to determine maximal load of a multidimensional plastic systems.

The principles and operation of a method and system according to the present embodiments may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Generally, the present embodiments exploit the use of graph theory by representing the analyzed systems using graph representations. Graph representation of a system is an isomorphic theoretical substitute of the system, which can be used for designing, analyzing, optimizing and characterizing the system. The purely mathematical essence of graph representations makes them convenient for computerization and enables them to provide tools for a generalized treatment of the systems. Manipulation of a mathematical graph includes the use of many types of mathematical axioms, theorems and methods. When the graph is associated with a particular system, the mathematical axioms, theorems and methods are naturally applicable also for the engineering system.

There are many types of graphs which can be used according to various exemplary embodiments of the invention.

One such graph is a flow graph representation (FGR) which can be used to represent flow networks or plastic systems (e.g., trusses). The FGR is a directed graph G(E, V) in which each edge, e ε E is associated with a vector quantity. The set E of all edges in the FGR includes at least one special edge termed a source edge. When the FGR represents a flow network, each source edge represents a source of flow and the other edges represent the network lines through which drain the flow from the source edge. When the FGR represents a plastic system, each source edge represents an external force acting on the plastic system, and the other edges represent the various element of the plastic system (cables, struts, rods and the like). The set E of the FGR may further comprise one or more sink edges. For flow network, the sink edges represent consumption elements; for plastic systems, the sink edges represent the reactions of the truss, whereby external forces flow from the source edges through the other edges, and flow back through the reactions.

Another graph representation which is contemplated in various exemplary embodiments of the invention is a potential graph representation (PGR), which can be used as a dual representation for the FGR. For example, when the FGR represents a truss, the PGR can represent a kinematical mechanism. The PGR is a directed graph G(E, V) in which each vertex v ε V of the graph is associated with a potential (e.g., a vector potential), and each edge e ε E corresponds to the difference (a vector difference if the potential is a vector potential) between the potentials associated with the vertices interconnected by the e. Similarly to the FGR, the PGR may also include special source edges and special sink edges. If the embodiment in which the PGR represents a kinematical mechanism, source edges can represent, for example, driving links.

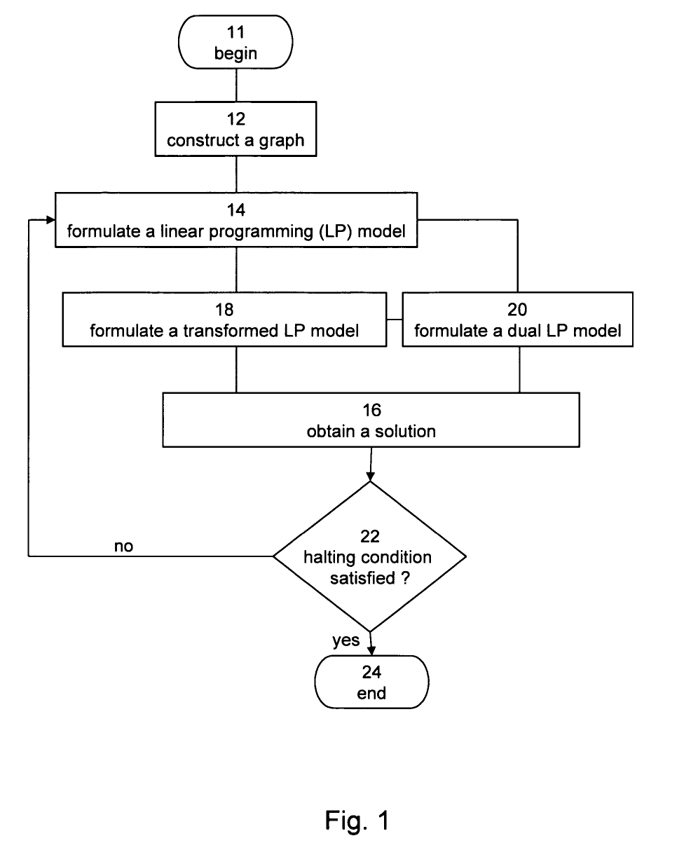

Referring now to the drawings, FIG. 1 is a flow chart of a method suitable for optimizing a flow network or determining a maximal load of a plastic system, according to various exemplary embodiments of the invention.

The method can be distributed on a program storage medium readable by a machine and tangibly embodying a program of instructions executable by the machine to perform the various steps of the method.

Computer programs implementing the method of the present embodiments can commonly be distributed to users on a distribution medium such as, but not limited to, a floppy disk or CD-ROM. From the distribution medium, the computer programs can be copied to a hard disk or a similar intermediate storage medium. The computer programs can be run by loading the computer instructions either from their distribution medium or their intermediate storage medium into the execution memory of the computer, configuring the computer to act in accordance with the method of this invention. All these operations are well-known to those skilled in the art of computer systems.

The method begins at step 11 and continues to step 12 in which, a multidimensional graph representation is constructed. The graph representation is multidimensional in the sense that each the edges of the graph are associated with a multidimensional vector quantity. It the simplest case, the vector quantity has two dimensions, higher dimensions (i.e., three or above) are also contemplated. The type graph representation can be any of the aforementioned types of graphs. The vector quantities associated with the edges of the graph are selected in accordance with the system which is analyzed.

Thus, when the system is a flow network, the vector quantities can be flow vectors each representing to a flow in a particular direction described by the respective vector. For a multidimensional plastic system, the vector quantities can be forces vectors, each representing to a force acting at a particular direction described by the respective vector. Higher dimensions of the vectors can represent additional information regarding the flow or the force.

The method proceeds to step 14 in which a linear programming (LP) model is formulated over the graph, and continues to step 16 in which an appropriate LP algorithm is used for obtaining a substantially optimal solution to the LP model. The LP algorithm can be any known LP algorithm, include, without limitation, simplex algorithm, primal-dual algorithm, primal-transformed algorithm and the like. Such algorithms are found, e.g., in Papadimitriou C. H. and Steiglitz, K. supra; and Danzig, G. B., Ford, L. R., and Fulkerson, D. R., 1956, “A Primal-Dual Algorithm for Linear Programming”, H. W. Kuhn and A. W. Tucker (ed.), Linear Inequalities and Related Systems, Princeton University Press, pp. 171-181. A complete algorithm for obtaining a substantially optimal solution is provided in the Examples section that follows.

Being a type of optimization problem, the LP model serves as an input to the LP algorithm, for optimizing an objective function which is expressed in terms of one or more of the vectors on the graph. The objective function typically comprises the vector(s) associated with the aforementioned source edge(s), such that the LP algorithm treats the vector quantities on the source edge(s) as unknowns and attempt to optimize them using the (typically known) vectors associated with the other edges. In various exemplary embodiments of the invention the vectors associated with the other edges represent bounds or constraints to be satisfied by the optimal solution which is sought.

As used herein, “substantial optimal solution” corresponds to a solution in which the objective function is evaluated to a close-to-highest or close-to-lowest value, depending on the definition of the objective function. Specifically, when the definition of the constraints or the objective function of the LP model are such that it is desired to maximize the objective function, the term “substantial optimal solution” refers to a value of the objective function which is slightly smaller (by no more than about 10%) or equals its maximal value; conversely, when the definition of the constraints or the objective function of the LP model are such that it is desired to minimize the objective function, the term “substantial optimal solution” refers to a value of the objective function which is slightly larger (again, by no more than about 10%) or equals its minimal value.

It is recognized that any max-flow problem of a flow network can be mapped onto a maximal load problem of static system. In various exemplary embodiments of the invention the graphic representation is used for transforming knowledge between the two problems. More specifically, when the multidimensional graph represents a flow network, its substantially optimal solution can be used to determine a maximal load on a multidimensional static system which corresponds to the same graph.

Before providing a further detailed description of preferred embodiment of the present invention as delineated hereinabove, attention will be given to the potential applications offered thereby.

Hence, the present embodiments can be employed in many areas of life including, without limitation, traffic design, commodity distribution, distributed partitioning, civil engineering and the like.

For example, in the area of traffic design, various exemplary embodiments of the invention can be used for determining the maximal traffic load in a feeding route (e.g., a main road, a highway, a bridge) from which traffic is directed to various other routes.

In the area of commodity distribution various exemplary embodiments of the invention can be used for determining the maximal rate of supply which can be supplied by a commodity source (e.g., a factory, a distributor) while minimizing or preventing “bottle-necks”.

In the area of distributed partitioning, various exemplary embodiments of the invention can be used to efficiently utilize varying resources of computing stations in a distributed computing environment, by optimizing the amount of information flowing from one or more of the stations.

In civil engineering, various exemplary embodiments of the invention can be used for determining the maximal load which can be applied on a construction (e.g., a building, a bridge, a podium), without exceeding the load capacity of the individual components of the construction.

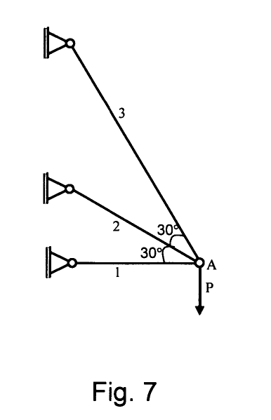

According to a preferred embodiment of the present invention the method comprises an additional step, designated 18 in FIG. 1, in which a transformed LP (TLP) model is formulated over the graph. The TLP model can be formulated by inverting a respective vector of at least one edge of the graph. When the vector represents flow, for example, such inversion corresponds to an artificial state of the flow network in which the direction of the flow is inverted. When the vector represents a force the inversion can be interpreted as switching from a compression force to a tension force or vise versa. As shown in FIG. 1, both the TLP model and the LP model can be used in an iterative manner until a substantially optimal solution is obtained. A representative example of an iterative primal-transformed LP algorithm is provided in Example 1 and FIG. 6 of the Examples section that follows.

As stated in the Background section above, every LP problem can be solved with the aid of a dual LP problem, which has a different set of constraints and a different objective function and which is complementary to the primal LP problem. In various exemplary embodiments of the invention the method comprises another step, designated 20 in FIG. 1, in which one or more dual LP models are formulated over the graph. This can be done in more then one way: in one preferred embodiment, the dual LP model is complementary to the LP model; in another preferred embodiment, the dual LP model is complementary to the TLP model; and in an additional preferred embodiment, two dual LP models are formulated: a first dual LP model which is complementary the LP model and a second dual LP model which is complementary to the TLP model.

The dual LP model(s) serve for establishing the halting conditions of the LP algorithm. Specifically, as shown in decision block 22, the LP algorithm can be configured to halt execution (termination block 24) when a predetermined halting condition is satisfied. For example, the execution can be halted when the objective function of one or both of the dual LP models arrives or being close to a global minimum (e.g., a zero).

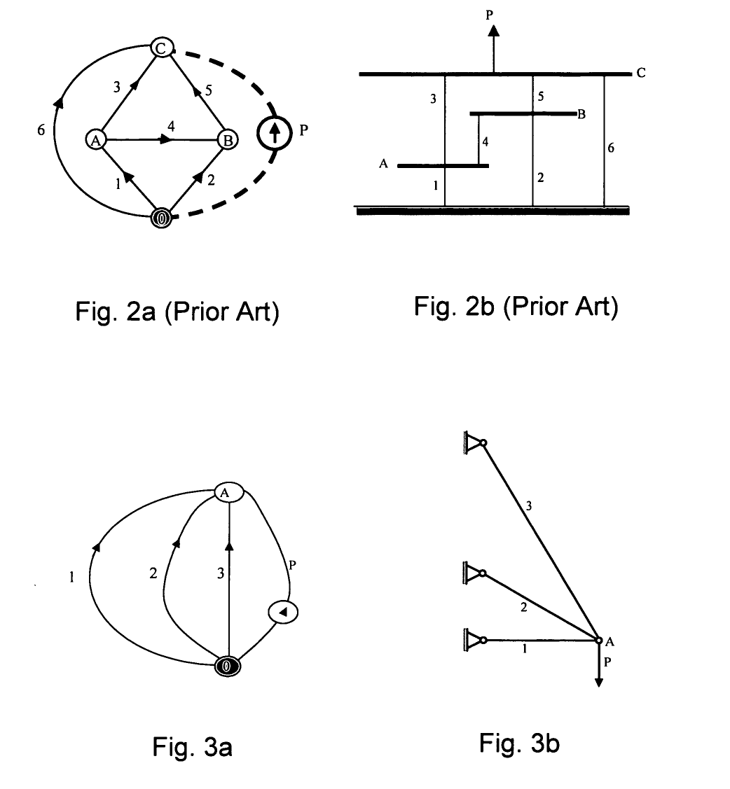

For purposes of better understanding the present embodiments, reference is first made to a one-dimensional max-flow problem and its corresponding LP model. FIGS. 2a-b show a one-dimensional flow network (FIG. 2a) and a one dimensional truss (FIG. 2b). In terminology of the flow network, the one-dimensional max-flow problem can be formulated as follows: given a directed network having a set E of edges and a source edge P, find the maximal flow in P such that the flows in each of the edges in E do not exceed the allowed capacities. The one-dimensional plastic system corresponding to the above one dimensional max-flow problem is formulated as follows: given a one-dimensional truss having a plurality of rods and a load P, find the maximal value of P that can be applied such that the yield limit is not exceeded in any of the rods.

The two problems can be formulated using the following LP model:

$$\begin{matrix}\begin{matrix}∀ v ∈ V & {\sum }_{e ∈ {E}^{′}}^{Max P} I ( e , v ) \cdot F ( e ) + I ( p , v ) \cdot P = 0 \\ ∀ e ∈ {E}^{′} & F ( e ) \leq {b}^{+} ( e ) \\ ∀ e ∈ {E}^{′} & - F ( e ) \leq {b}^{-} ( e ) \\ ∀ e ∈ {E}^{′} & F ( e ) \text{≤>} 0 \\ & P > 0\end{matrix} & ( EQ . 1 )\end{matrix}$$

where, V is the set of vertices of the network; E′ is the set of edges that are not sources; I(e,v) is a function of adjacency between edge e and vertex v (I=1 if v is the head vertex of e, I=−1 if v is the tail vertex, and I=0 otherwise); F(e) is the flow in edge e; b⁺(e) and b⁻(e) are, respectively, upper and lower bounds of the flow through edge e.

The dual LP model complementary to Equation 1 reads:

$$\begin{matrix}Min {\sum }_{\begin{matrix}∀ edge e = ( t , h ) \\ in the network\end{matrix}} {γ}^{+} ( t , h ) {b}^{+} ( t , h ) + {\sum }_{\begin{matrix}∀ edge e = ( t , h ) \\ in the network\end{matrix}} {γ}^{-} ( t , h ) {b}^{-} ( t , h ) \\ \begin{matrix}π ( h ) - π ( t ) + {γ}^{+} ( t , h ) - {γ}^{-} ( t , h ) \geq 0 & ( for each edge e = ( t , h ) ) \\ - π ( {t}_{p} ) + π ( {h}_{p} ) \geq 1 & ( for the source edge p = ( {t}_{p} , {h}_{p} ) ) \\ π <> 0 & \\ {γ}^{+} ( t , h ) \geq 0 & \\ {γ}^{-} ( t , h ) \geq 0 & \end{matrix} & ( EQ . 2 )\end{matrix}$$

Where: h and t are, respectively, the head and tail vertices of an edge e; π(v) is a variable associated with every vertex of the network and can be interpreted as a potential variable of the network; γ⁻(t,h) and γ⁺(t,h) are associated with every edge of the network, which can be interpreted as positive and negative potential differences of the edge.

The optimal solutions to the LP model (Equation 1) and the dual LP model (Equation 2) obey the well known complementary slackness relations [Hillier, F. S. and Lieberman, G. J., 1990, “Introduction to Mathematical Programming, McGRAW-Hill Inc, New York]
a. γ⁺(e)(b⁺(e)−F(e))=0
b. γ⁻(e)(b⁻(e)+F(e))=0 (EQ. 3)

The LP dual model is defined upon variables which are associated with the network, both through the formulation itself and through the complementary slackness relations. Thus, as will be appreciated by one of ordinary skill in the art, the dual LP model can be associated with the flow network (FIG. 2a), and, consequently, with the plastic system (FIG. 2b).

In the terminology of network flows, the dual LP model can be interpreted as follows: find a minimal cutset in the network such that the sum of the capacities of its edges is minimal. According to the complementary slackness conditions, an edge belongs to a minimal cutset if and only if in the maximum flow solution, the flows in these edges are equal to their capacity (the edges are saturated).

In the terminology of Equation 2, π(v)=1 if vertex v is from one side of the minimal cutest (same side as the tail vertex of the source edge), and π(v)=0 otherwise; γ⁺(t,h)=1 if edge (t,h) belongs to the minimal cutset and is oriented in the forward direction relatively to the cutset; and γ⁻(t,h)=1 if edge (t,h) belongs to the minimal cutset and is oriented in the backward direction relatively to the cutset.

In the terminology of the one-dimensional static system (FIG. 2b) the dual LP model can be interpreted as follows: find the “minimal work plastic mechanism” defined by a set of rods to be put in the yield limit in order to turn the truss into a mechanism (a rod arriving into its yield limit is referred to in the literature as being in a plastic mode because in such situation the rod can assume any deformation). The objective function of the dual LP model is typically defined as the sum of the yield limits of the plastic rods. This objective function equals the work applied upon these rods if the joint of the external force moves a unit of length in the direction of the external force, hence can be considered as an energy function for which a minimum is sought.

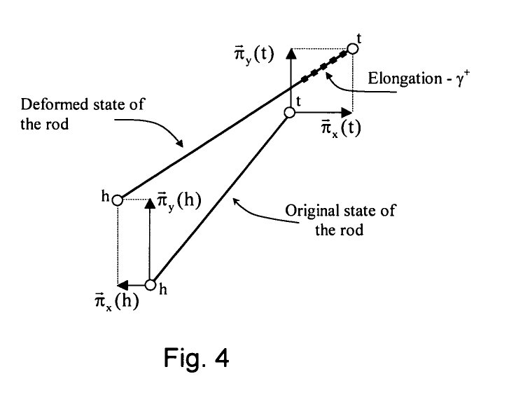

Reference is now made to FIGS. 3a-b which are schematic illustrations of a two-dimensional flow network (FIG. 3a) and its corresponding two-dimensional plastic system (FIG. 3b), according to a preferred embodiment of the present invention.

In the two-dimensional flow network, the flows associated with the edges are two-dimensional vectors. The continuity condition for the flows in the network, possess a vector form. Specifically, the vector sum of the flows at each network vertex is zero. By allowing the flows to be vectors, the network can now be used to represent multidimensional systems, such as plane and spatial trusses, where each rod possesses different inclination. According to the presently preferred embodiment of the invention the flows of the networks are directed at a predetermined (constant) angle. It is to be understood, however, the variable angles are not excluded from the scope of the present invention.

The two-dimensional problem of the flow network is preferably as follows: given a two-dimensional network (see FIG. 3a), in which the flows are vectors with predetermined angles, find the maximal magnitude of the flow in the source edge P, such that the magnitudes of the flows in the edges do not exceed the allowed capacities.

The corresponding two-dimensional problem for the plastic system is preferably: given a two-dimensional truss (see FIG. 3b) find the maximal load P that can be applied such that the yield limit is not exceeded in any of the rods.

The two problems can be formulated using the following LP model:

$$\begin{matrix}\begin{matrix}∀ v ∈ V & {\sum }_{e ∈ {E}^{′}}^{Max P} I ( e , v ) \cdot F ( e ) \cdot cos ( α ( e ) ) + I ( p , v ) \cdot P \cdot cos ( α ( p ) ) = 0 \\ ∀ v ∈ V & {\sum }_{e ∈ {E}^{′}} I ( e , v ) \cdot F ( e ) \cdot sin ( α ( e ) ) + I ( p , v ) \cdot P \cdot sin ( α ( p ) ) = 0 \\ ∀ e ∈ {E}^{′} & F ( e ) \leq {b}^{+} ( e ) \\ ∀ e ∈ {E}^{′} & - F ( e ) \leq {b}^{-} ( e ) \\ ∀ e ∈ {E}^{′} & F ( e ) \text{≤>} 0 \\ & P > 0\end{matrix} & ( EQ . 4 )\end{matrix}$$

Where F(e) is the magnitude of the flow in edge e and α(e) is the angle outlining its direction.

The first two constraints in Equation 4 are the flow continuity conditions, according to which the amount of flow entering the vertex along each base vector is equal to the amount of flow leaving the vertex along the same base vector. The first constraint is the continuity condition for flows along one base vector (e.g., the x axis), and the second constraint is the continuity condition for flows along a second base vector (e.g., the y axis).

The flow magnitudes are multiplied by the cosines of the angles of the corresponding edges and by a sign function, I(e,v), indicating whether vertex v is the tail or the head vertex of edge e, as further detailed above.

The third and fourth constrains in Equation 4 set the minimal and maximal boundaries for the flow. In the truss (FIG. 3b) the third and fourth constrains correspond to the maximal tension and the maximal compression that can be applied upon the corresponding rod.

The symbol “≦>” appearing in the fifth line of Equation 4 stands for an unconstrained quantity. Thus, according to the presently preferred embodiment of the invention F(e) can have any sign (positive, negative or zero).

The dual LP model complementary to Equation 4 is preferably:

$$\begin{matrix}\begin{matrix} & \begin{matrix}Min {\sum }_{e ∈ {E}^{′}} {b}^{+} ( e ) \cdot {γ}^{+} ( e ) + \\ {\sum }_{e ∈ {E}^{′}} {b}^{-} ( e ) \cdot {γ}^{-} ( e )\end{matrix} \\ ∀ ( e = < t , h > ) ∈ {E}^{′} & ( {π}_{x} ( t ) - {π}_{x} ( h ) ) \cdot cos ( α ( e ) ) ++ \\ & \begin{matrix}( {π}_{y} ( t ) - {π}_{y} ( h ) ) \cdot sin ( α ( e ) ) + \\ {γ}^{+} ( e ) - {γ}^{-} ( e ) = 0\end{matrix} \\ for ( p = < o , {v}_{p} > ) & {π}_{x} ( {v}_{p} ) \cdot cos ( α ( p ) ) + {π}_{y} ( {v}_{p} ) \cdot sin ( α ( p ) ) \geq 1 \\ ∀ v ∈ V & {π}_{x} ( v ) , {π}_{y} ( v ) \leq \geq 0 \\ ∀ e ∈ {E}^{′} & {γ}^{+} ( e ) , {γ}^{-} ( e ) \geq 0\end{matrix} & ( EQ . 5 )\end{matrix}$$

There are four types of variables in Equation 5: πₓ, π_{y}, γ⁺ and γ⁻, where πₓ, π_{y} are associated with vertices, and γ⁺, γ⁻ are associated with edges.

The first constraint in Equation 5 defines πₓ and π_{y} as vector potentials along the two base vectors and γ⁺ and }⁻ are potential differences associated with edges. In the two-dimensional plastic system (FIG. 3b), the potentials πₓ, π_{y}, can be seen as the displacements of the corresponding joints in x and y directions, and the potential differences γ⁺, γ⁻, can be seen as length variation of the rod. For example, γ⁺ can correspond to an elongation and γ⁻ can correspond to shortening of the rod.

The second constraint in Equation 5 can be interpreted as a requirement that the displacement of the joint upon which the external force is applied is higher or equal than a unit of length.

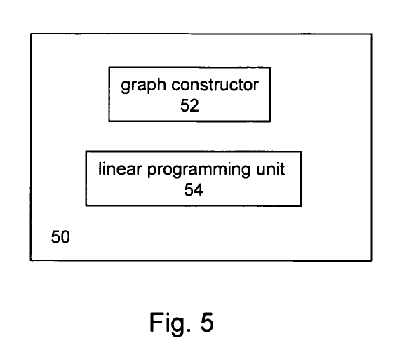

Reference is now made to FIG. 4 which is a schematic illustration of one rod before and after deformation. In the exemplified illustration the rod e is elongated (the extent of elongation is designated γ⁺) as a result of: (i) displacements of one end of the rod (the “head”) by πₓ(h) along the x direction and π_{y}y(h) along y direction; and (ii) displacements of another end (the “tail”) by πₓ(t) along the x direction and π_{y}(t) along y direction.

The dual LP two-dimensional problem can be formulated as follows: find a minimal two-dimensional cutset in the network, which, upon removing the cutset from the network the flow through the network is blocked.

It will be appreciated that the multidimensional cutset differs in its properties from the cutsets accustomed in one-dimensional networks. In a one-dimensional network, a set of edges is considered a cutset only if its removal from the network renders the network a disconnected network. Such a criterion is unnecessary in the multidimensional cutset defined according to various exemplary embodiments of the invention because the multidimensional network does not have to be disconnected to block the transfer of two-dimensional flow.

In the terminology of the two-dimensional truss the dual problem can be formulated as follows: find the “minimal work plastic mechanism”, defined by a set of rods to be put in the yield limit in order to turn the truss into a mechanism. Each rod has two possible plastic modes: a compression mode, in which the rod can be shortened, and a tension mode in which the rod can be elongated. In the engineering terminology, these modes can be considered as replacement of the rods with cables for tension mode and struts for compression mode. The objective function of the dual LP model is preferably defined as the sum of the products of the yield limits of the chosen rods by their elongation in the mechanism when the joint of external force is moved by a unit of length in the direction of the force.

The above interpretation is reinforced by the complementary slackness relations, from which it follows that the y variables can differ from zero only if the corresponding edge in the dual LP model is saturated. Specifically, γ⁺ differs from zero when the edge reaches its maximal bound, and γ⁻ differs from zero when the edge reaches its minimal bound. In the terminology of the plastic system, a particular rod can be deformed only if it is saturated: shortened when being saturated by a compressive force and elongated when being saturated a tensile force. Thus, depending on the nature of saturation, a saturated rod can be considered as being replaced by a cable which can only be elongated or a strut which can only be shortened.

As stated, the LP, TLP and dual models can be employed in an iterative process to obtain the substantially optimal solution. According to a preferred embodiment of the present invention, at each step of the iterative procedure, a new TLP model of Equation 4 is constructed, preferably using the values of the variables of the LP and dual models of the preceding iteration.

The TLP model typically has the same number of variables and constraints, and is preferably constructed by inverting vectors which are saturated. In the terminologies of the two-dimensional network, the TLP model is formulated as follows: when the flow in a particular edge of the LP model is saturated, the corresponding edge in the TLP model allows flow opposite to the saturation flow, otherwise the edge of the TLP model is the same as in the LP model.

In the terminologies of the two-dimensional plastic system the TLP model is formulated as follows: when a particular rod of the LP model is saturated, the corresponding rod in the TLP is replaced by a cable or a strut, depending on the type of saturation. Specifically rods saturated by a compression force are replaced by cables, and rods saturated by a tension force are replaced by struts. Rods which are not saturated are not replaced.

Conveniently, the variables of the TLP model are defined such that their value is smaller than or equal one. Additionally, the constraints of the TLP model are preferably constructed such that the constrained quantities are bounded by zero. Thus, according to the presently preferred embodiment of the invention magnitudes of the flows and forces in the saturated edges or rods are limited to be no greater than 1.

Mathematically, the TLP model can be written as:

$$\begin{matrix}\begin{matrix}∀ v ∈ V & \begin{matrix}{\sum }_{e ∈ {E}^{′}}^{{Max P}^{T}} I ( e , v ) \cdot {F}^{T} ( e ) \cdot cos ( α ( e ) ) + \\ I ( p , v ) \cdot {P}^{T} \cdot cos ( α ( p ) ) = 0\end{matrix} \\ ∀ v ∈ V & \begin{matrix}{\sum }_{e ∈ {E}^{′}} I ( e , v ) \cdot {F}^{T} ( e ) \cdot sin ( α ( e ) ) + \\ I ( p , v ) \cdot {P}^{T} \cdot sin ( α ( p ) ) = 0\end{matrix} \\ ∀ e ∈ {J}^{+} & 0 \geq {F}^{T} ( e ) \geq - 1 \\ ∀ e ∈ {J}^{-} & 1 \geq {F}^{T} ( e ) \geq 0 \\ ∀ e ∈ {E}^{′} & {F}^{T} ( e ) \text{≤>} 0 \\ & 1 \geq {P}^{T} > 0\end{matrix} & ( EQ . 6 )\end{matrix}$$

where the superscript indicates the transformed LP model, and J^{±}denote sets of all saturated constraints (constraints for which equality is satisfied) in the respective iteration.

Once an optimal solution to the TLP model is found, the LP model can be updated for the next iteration. The update of the LP model is preferably using one or more augmentation coefficients which facilitate the augmentation of solutions of successive iterations. A typical definition of an augmentation coefficient is the minimal ratio between the deviation from equality of the unsaturated constraints in the LP model and the constraints in the TLP model. Thus, denoting the augmentation coefficient by θ, the deviation from equality of the jth constraint of the LP model by Δⱼ and the deviation from equality of the jth constraint of the TLP model by Δ^{T}ⱼ:

$$θ = {Min}_{∀ j ∉ J} \frac{{Δ}_{j}}{{Δ}_{j}^{T}} \qquad ( EQ . 7 )$$

Δⱼ and Δ^{T}ⱼ can be defined, for example, by subtracting the right-hand-side (RHS) from the left-hand-side (LHS) of the jth constraint. In the embodiments in which the TLP model has a zero RHS (see Equation 6), Δ^{T}ⱼ is simply the LHS of the jth constraint.

Each variable of the updated LP model is preferably calculated by adding to its previous value the value of the corresponding TLP model variable multiplied by 0. Thus, for example, once the ith iteration is completed, the variable F(e) of the LP model can be updated as follows:
Fᵢ₊₁(e)=Fᵢ(e)+θ Fᵢ^{T}(e) (EQ. 8)

Typically, in the first iteration some initial solution is given to the variables of the LP model, such that the constraints are satisfied. For example, the initial solution can be such that all the variables are set to be equal to zero. As the iteration procedure evolves, the TLP models are formulated and the variable values are updated until a halting condition is achieved (e.g., using the dual LP and/or dual TLP models).

The above method steps can be executed by an apparatus 50 for optimizing multidimensional flow network or determining maximal load of a multidimensional static system.

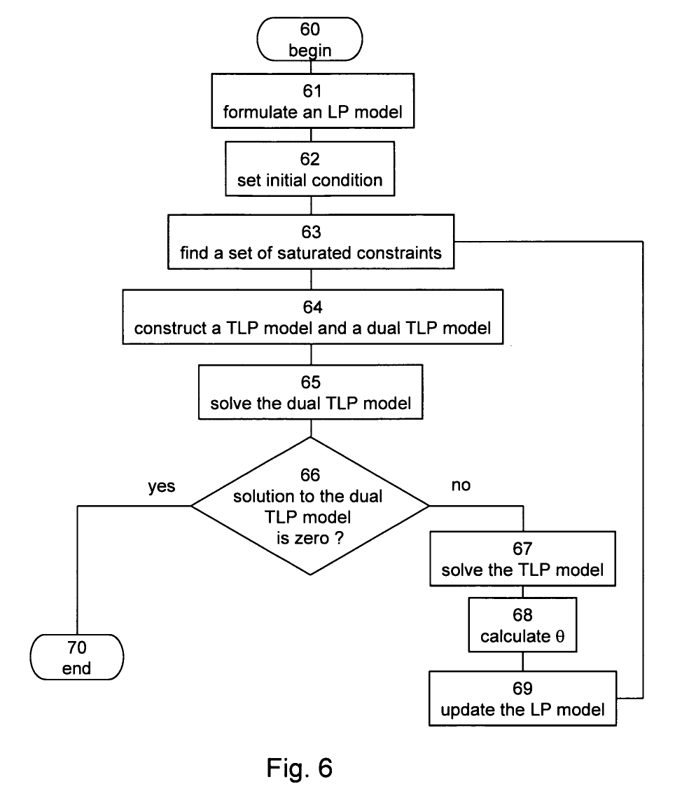

Reference is now made to FIG. 5 which is a schematic illustration of apparatus 50. Apparatus 50 preferably comprises a graph constructor 52, for constructing a multidimensional graph representation, and a linear programming unit 54 for formulating a LP model and optionally TLP model. Unit 54 can also formulate one or more dual LP models as further detailed hereinabove. Unit 54 applies an LP algorithm so as to obtain a substantially optimal solution to the LP model, as further detailed hereinabove.

As used herein the term “about” refers to ±10%.

Additional objects, advantages and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Reference is now made to the following examples, which together with the above descriptions illustrate the invention in a non limiting fashion.

### Example 1

Following is a description of a linear programming algorithm which employs an iterative procedure, according to various exemplary embodiments of the invention. The algorithm is schematically illustrated in the flowchart of FIG. 6.

For each given original optimization problem the algorithm constructs a transformed optimization problem that is easier to be solved. Once solved, the solution of the transformed problem is augmented to the solution of the original problem after multiplication by the augmentation coefficient, θ.

The algorithm begins at step 60 and continues to step 61 in which the original LP model is formulated. The LP model includes inequality constraints for the model variables and an objective function which is to be optimized. The algorithm continues to step 62 in which an initial solution is given to the variables, such that the constraints are satisfied. Suitable initial solution is, without limitation, when all the variables are set to be equal to zero. Table 1, below describes step 62 in the terminologies of two-dimensional networks and two-dimensional trusses.

TABLE 1

| Two-dimensional network | Truss |
|---|---|
| Set all the flows in the network to be | Set all the forces in the |
| zero vectors. | truss to be zero vectors. |

The algorithm then continues to step 63 in which a set J of admissible constraints is found. Upon the substitution of the current values of the variables into the constraints of the original problem, several constraints are satisfied in equality form and several constraints are satisfied in inequality form. The constraints that are satisfied in equality form are referred to herein as saturated constraints. Set J is defined as the collection of all the saturated constraints. Table 2 below describes step 63 the terminologies of two-dimensional networks and two-dimensional trusses.

TABLE 2

| Two-dimensional network | Truss |
|---|---|
| Set J is a set of edges for which the | Set J is a set of rods where at the |
| constraints limiting their capacity are | current iteration the internal force |
| found to be saturated. Since there are | has reached the maximal yield |
| two types of such constraints, for | limit. Since there are two types of |
| positive and negative flows, set J is | such constraints, for compression |
| preferably divided into two sets J⁺ | and tension forces, set J is |
| for positive saturation and J⁻ | preferably divided into two sets J⁺ |
| for negative saturation. | for compressive saturation and |
| | J⁻, for tensile saturation. |

The algorithm proceeds to process step 64 in which the TLP model and its dual model are constructed, as further detailed above (see Equation 6 and the accompanying description). The objective function, W, of the TLP model and/or dual TLP model is preferably selected such that W=0 indicates that the optimal solution is found. Once the TLP and dual TLP models are constructed the algorithm continues to step 65 and solves the dual TLP model. The algorithm then proceeds to decision step 66. If W=0 (or sufficiently small) the algorithm continues to termination block 70 and halts.

Table 3 below describes the halting condition for the TLP and dual TLP models for the two terminologies.

TABLE 3

| Two-dimensional network | Truss |
|---|---|
| Dual transformed problem: | Dual transformed problem: |
| If there is no admissible flow that can | If no positive external force can be applied |
| be initiated from the source, the optimal | on it, the optimal solution or the maximal |
| solution or the maximal flow has been | loading has been reached and the algorithm |
| reached and the algorithm halts. | halts. |
| Transformed problem: | Transformed problem: |
| If the saturated edges form a vector | If the transformed truss allows the external |
| cutset (a set of edges blocking the | forces to move a unit displacement |
| admissible flow), the optimal solution has | without producing forces in any of its |
| been found and the algorithm halts. | members, the optimal solution has been |
| | reached and the algorithm halts. |

If the halting condition is not satisfied (W>0), the algorithm continues to process block 67 and solves the TLP model. The transformed model possesses a restricted form in comparison to the original model. As the constraints in the TLP model are simpler than the constraints of the original LP model, finding the optimal solution to the transformed model is, in principle, a simpler task than finding the solution to the original problem. The TLP model can be solved using any procedure known in the art (see, e.g., Recski, A., 1989, “Matroid Theory and its Applications in Electric Network Theory and in Statics”, Springer, Berlin). Table 4 below describes step 67 for the two terminologies.

TABLE 4

| Two-dimensional network | Truss |
|---|---|
| Find a set of edges capable of conducting | In the transformed truss, |
| an admissible two-dimensional flow in | select a subset of truss |
| the transformed network. In these edges, | elements forming a stable |
| find the flow distribution if the source | determinate truss. Apply a |
| edge conducts a flow of a unit magnitude. | unit loading to the truss in the |
| | direction of the external forces |
| | and find the forces in the rods |
| | of the transformed truss. |

Once a solution to the TLP model is found, the algorithm continues to step 68 and calculates the augmentation coefficient θ (see Equation 7). The algorithm then proceeds to step 69 in which the LP model is updated (see Equation 8) and loops back to process block 63.

### Example 2

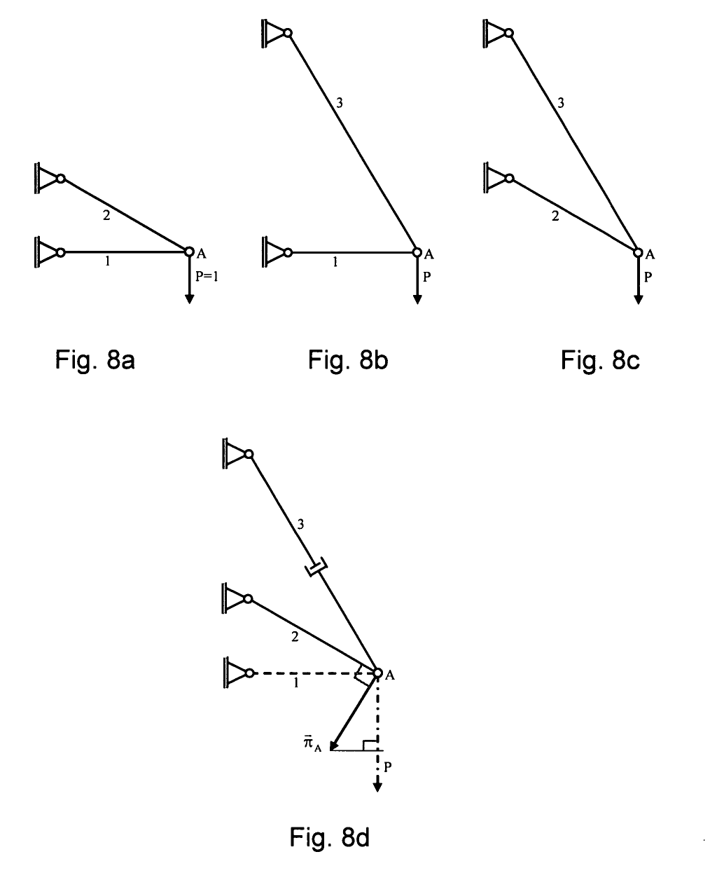

The present example demonstrates the determination of a maximal load of a two dimensional truss, using the algorithm described in Example 1. The truss is illustrated in FIG. 7 and comprises three rods, designated 1, 2 and 3, respectively oriented at angles of 0°, 30° and 60° above the horizontal direction. The compressive and tensile yielding of all the truss rods of the present example is equal to 12,000 N. A vertical external force P acts on a joint A of rods 1, 2 and 3.

The initial feasible solution is set to be P=F₁=F₂=F₃=0.

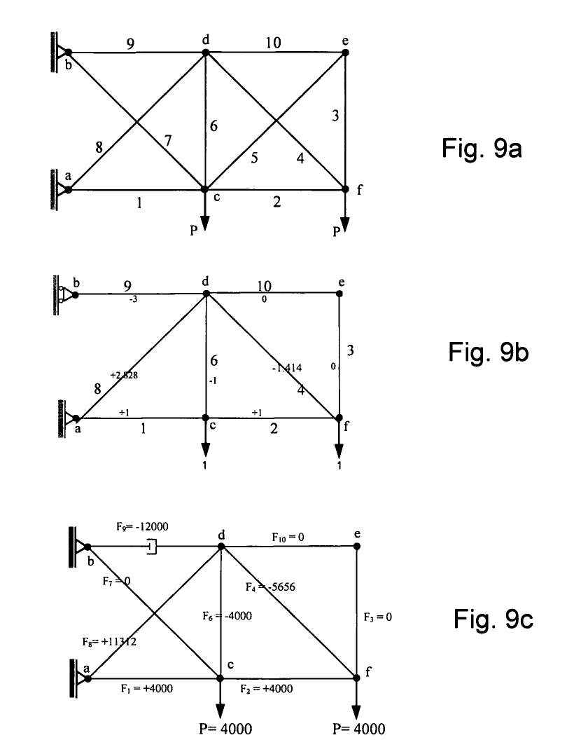

For the first iteration, there are no saturated rods, thus in the transformed truss, there is no restriction on the direction of the forces in the rods. One of the possible solutions, shown in FIG. 8a, is obtained by removing rod 3 from the truss and applying on it a unit external force.

The analysis of the truss of FIG. 8a results in P′=1 N, F′₁=1.756 N and F′₂=−2.02 N. The updated LP model is obtained by multiplying these forces by the augmentation coefficient θ=5,940.6 and adding to the previous solution. The current solution thus becomes P=5,940.6 N, F₁=10,431.7 N, F₂=12,000 N and F₃=0.

Rod 2 became saturated by tension (its force is negative in sign and equals the yield in magnitude). According to a preferred embodiment of the present invention in the TLP model, rod 3 is transferred to the set of admissible constraints, J⁻, which includes all the rods that can be lengthened in the original truss but cannot sustain tension. In engineering terminology, this rod is replaced with a strut. According to a preferred embodiment of the present invention the objective of the dual problem is to find a set of saturated rods such that the truss is turned into a mechanism. This goal has not yet been achieved, because rods 1 and 3 are non-saturated and prevent the movement of joint A in the direction of the external force.

Thus, a second iteration is performed in which F₂ is unloaded or in the state of compression. FIG. 8b exemplifies one of the possible solutions. In this solution rod 2 is removed from the truss and the unit external force is applied upon the new transformed truss.

The analysis of the truss of FIG. 8b results in P′=1 N, F′₁=0.577 N and F′₃=−1.154 N. The updated LP model is obtained by multiplying these forces by the augmentation coefficient θ=2,718 and adding to the previous solution. The current solution thus becomes P=8,658.6 N, F₁=12,000 N, F₂=−12,000 N and F₃=−3,136.

The current solution has two saturated rods: rod 1 has reached the tensile yielding and rod 2 has reached the compressive yielding. The saturated constraint sets are therefore J⁻={2} and J⁺={1}.

Turning rods 1 and 2 into plastic mode enables movement of joint A. Nevertheless, the optimal solution has not been yet achieved because when rod 2 is a strut and rod 1 is a cable, joint A can not move in the direction of the external force.

Thus, a third iteration is performed in which rod 1 is limited to be in tension (cable) and rod 2 is limited to be in compression (strut). FIG. 8c illustrates a possible solution of the third iteration in which rod 1 is removed and a unit external force is applied on the truss.

The analysis of the truss of FIG. 8c results in P′=1 N, F′₂=0.991 N and F′₃=−1.721 N. Since the force in rod 2 in the transformed truss is positive, and in the original truss it is strut, the constraints of transformed problem have not been violated. The updated LP model is obtained by multiplying these forces by the augmentation coefficient θ=5,150.14 and adding to the previous solution. The current solution thus becomes P=13,808.8 N, F₁=12,000 N, F₂=−6,896.2 N and F₃=−12,000.

One of ordinary skill in the art would appreciate that rod 2 is no longer saturated and can therefore be removed from set J⁻. On the other hand, rod 3 has reached the compressive yielding hence J⁻={3}.

FIG. 8d shows the original truss in the current iteration. As shown, rod 3 is strut and rod 1 is a cable. Joint A can move in perpendicularly to rod 2 without causing deformation to any of the truss elements. The displacement vector, \vec{π}_{A} has a positive component in the direction of the external force. Thus, the truss is now a mechanism and goal of the dual LP model is accomplished.

### Example 3

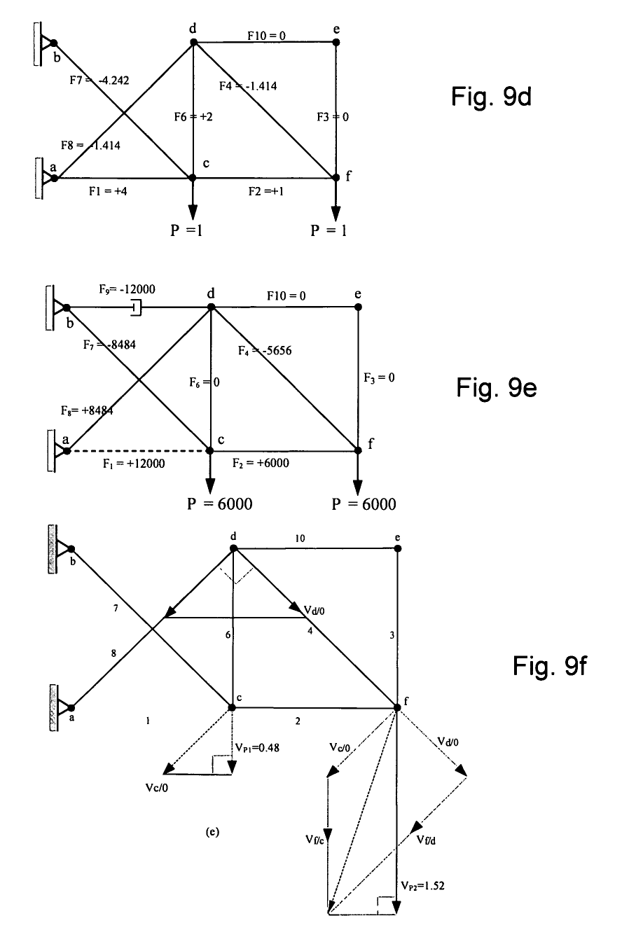

The present example demonstrates the determination of a maximal load of an additional two dimensional truss, using the algorithm described in Example 1. The truss is illustrated in FIG. 9a and comprises ten rods, designated by numerals 1-10. Rods 1, 2, 9 and 10 are oriented along the x direction, rods 3 and 6 are oriented along the y direction and all other rods form a 45° angle with the x and y axes. The compressive and tensile yielding of all the truss rods of the present example is equal to 12,000 N.

In the first iteration a zero force is assigned to all the rods, hence sets J^{±} are the empty sets. The truss is stable hence no movement of the joints can occur without causing deformation of truss members. The dual TLP model is therefore not optimal.

The solution to the TLP in the first iteration is shown in FIG. 9b. The solution is obtained by removing rods 5 and 7 and solving the obtained truss. The corresponding value for θ is 4,000.

FIG. 9c shows the truss at the beginning of the second iteration. There is still no positive saturation and set J⁺ remains the empty set. On the other hand rod 9 is negatively saturated and therefore J⁻={9}. Being a member of the J⁻ set rod 9 is replaced by a strut. Nevertheless the truss remains stable and the dual TLP model is still not optimal.

The solution to the TLP in the second iteration is shown in FIG. 9d. The solution is obtained by removing rods 5 and 9 and solving the obtained truss. The corresponding value for θ is 2,000.

FIG. 9e shows the truss at the beginning of the third iteration. Rod 1 is positively saturated and therefore J⁺={1}. Rod 9 is still negatively saturated thus J⁻={9}. Rod 1 is thus replaced by a cable and rod 9 by a strut.

FIG. 9f shows the solution to the dual TLP model. Joints c and f are capable of moving in the direction of the external forces without causing deformation in the truss members. The solution of the dual transformed problem is zero hence the optimal solution to the original problem has been reached. The maximal load of the truss is therefore 6000 N.

Table 5 below summarizes the values of the variables obtained during the iterative process for the LP and TLP models.

TABLE 5

| | | |
|---|---|---|
| Iteration I | Iteration II | Iteration III |

| Variable | LP | TLP | LP | TLP | LP |
|---|---|---|---|---|---|
| F₁ | 0 | 1 | 4000 | 4 | 12000 |
| F₂ | 0 | 1 | 4000 | 1 | 6000 |
| F₃ | 0 | 0 | 0 | 0 | 0 |
| F₄ | 0 | −1.41 | −5656 | −1.41 | −5656 |
| F₅ | 0 | 0 | 0 | 0 | 0 |
| F₆ | 0 | −1 | −4000 | 2 | 0 |
| F₇ | 0 | 0 | 0 | −4.24 | −8484 |
| F₈ | 0 | 2.83 | 11312 | −1.41 | 8484 |
| F₉ | 0 | −3 | −12000 | 0 | −12000 |
| F₁₀ | 0 | 0 | 0 | 0 | 0 |
| P | 0 | 1 | 4000 | 1 | 6000 |

| | | | |
|---|---|---|---|
| dual TLP | stable | stable | mechanism |

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A method of optimizing a flow network, comprising:
constructing a multidimensional graph representation of the flow network, said multidimensional graph representation being characterized by a plurality of vertices and a plurality of edges, whereby at least one edge of said plurality of edges is associated with a vector quantity over the flow network;
formulating a linear programming model over said multidimensional graph representation; and
using linear programming algorithm for obtaining a substantially optimal solution to said linear program model, thereby optimizing the flow network.

2. The method of claim 1, further comprising using said substantially optimal solution for determining a maximal load of a multidimensional static system corresponding to said multidimensional graph representation.

3. The method of claim 2, further comprising formulating a transformed linear programming model over said multidimensional graph representation.

4. A method of determining a maximal load of a multidimensional static system, the method comprising:
constructing a multidimensional graph representation of the multidimensional static system, said multidimensional graph representation being characterized by a plurality of vertices and a plurality of edges, whereby at least one edge of said plurality of edges is associated with a vector quantity over the multidimensional static system;
formulating a linear programming model over said multidimensional graph representation; and
using a linear programming algorithm for a obtaining a substantially optimal solution to said linear program model, thereby determining the maximal load of the multidimensional static system.

5. The method of claim 4, further comprising formulating a transformed linear programming model over said multidimensional graph representation.

6. The method of claim 3, further comprising formulating a first dual linear programming model over said multidimensional graph representation, said first dual linear programming model being complementary to said linear programming model.

7. The method of claim 6, wherein said linear programming algorithm comprises a primal-dual algorithm.

8. The method of claim 7, wherein said linear programming algorithm comprises a combination of a primal-transformed algorithm and a primal-dual algorithm.

9. The method of claim 6, wherein said linear programming algorithm is configured to halt execution when said first dual linear programming model satisfies a predetermined halting condition.

10. The method of claim 3, further comprising formulating a second dual linear programming model over said multidimensional graph representation, said second dual linear programming model being complementary to said transformed linear programming model.

11. The method of claim 10, wherein said linear programming algorithm is configured to halt execution when said second dual linear programming model satisfies a predetermined halting condition.

12. The method of claim 3, wherein said transformed linear programming model is defined by inverting a respective vector quantity of at least one edge of said plurality of edges.

13. The method of claim 6, wherein said first dual linear programming model comprises potential variables being associated with vertices of said multidimensional graph representation, and potential-difference variables being associated with edges of said multidimensional graph representation.

14. The method of claim 10, wherein said second dual linear programming model comprises potential variables being associated with vertices of said multidimensional graph representation, and potential-difference variables being associated with edges of said multidimensional graph representation.

15. The method of claim 13, wherein said potential variables correspond to displacements of joints of said multidimensional static system.

16. The method of claim 13, wherein said potential-difference variables correspond to length variations of rods of said multidimensional static system.

17. The method of claim 13, wherein said potential variables correspond to displacements of joints of said multidimensional static system.

18. The method of claim 13, wherein said potential-difference variables correspond to length variations of rods of said multidimensional static system.

19. An apparatus for determining maximal load of a multidimensional static system, the apparatus comprising:
a graph constructor, for constructing a multidimensional graph representation of the multidimensional static system, said multidimensional graph representation being characterized by a plurality of vertices and a plurality of edges, whereby at least one edge of said plurality of edges is associated with a vector quantity over the multidimensional static system; and
a linear programming unit for formulating a linear programming model over said multidimensional graph representation, said linear programming unit being configured to apply a linear programming algorithm so as to obtain a substantially optimal solution to said linear program model, thereby to determine the maximal load of the multidimensional static system.

20. The apparatus of claim 19, wherein said linear programming unit is operable to formulate a transformed linear programming model over said multidimensional graph representation.

21. The apparatus of claim 1, wherein said linear programming unit is operable to formulate a first dual linear programming model over said multidimensional graph representation said first dual linear programming model being complementary to said linear programming model.

22. The apparatus of claim 21, wherein said linear programming algorithm comprises a primal-dual algorithm.

23. The apparatus of claim 22, wherein said linear programming algorithm comprises a combination of a primal-transformed algorithm and a primal-dual algorithm.

24. The apparatus of claim 21, wherein said linear programming algorithm is configured to halt execution when said first dual linear programming model satisfies a predetermined halting condition.

25. The apparatus of claim 20, wherein said linear programming unit is operable to formulate a second dual linear programming model over said multidimensional graph representation said second dual linear programming model being complementary to said transformed linear programming model.

26. The apparatus of claim 25, wherein said linear programming algorithm is configured to halt execution when said second dual linear programming model satisfies a predetermined halting condition.

27. The method claim 3, wherein said linear programming algorithm comprises a primal-transformed algorithm.

28. The method of claim 27, wherein said primal-transformed algorithm is configured to iteratively update said substantially optimal solution using at least one augmentation coefficient.

29. The method of claim 1, wherein said vector quantity is a two-dimensional vector quantity.

30. The apparatus of claim 21, wherein said first dual linear programming model comprises potential variables being associated with vertices of said multidimensional graph representation, and potential-difference variables being associated with edges of said multidimensional graph representation.

31. The apparatus of claim 25, wherein said second dual linear programming model comprises potential variables being associated with vertices of said multidimensional graph representation, and potential-difference variables being associated with edges of said multidimensional graph representation.

32. The apparatus of claim 30, wherein said potential variables correspond to displacements of joints of said multidimensional static system.

33. The apparatus of claim 30, wherein said potential-difference variables correspond to length variations of rods of said multidimensional static system.

34. A program storage medium readable by a machine, tangibly embodying a program of instructions executable by the machine to perform the method of claim 1.

35. A program storage medium readable by a machine, tangibly embodying a program of instructions executable by the machine to perform the method of claim 4.
